(19) United States
(12) Patent Application Publication
(10) Pub. No.: US 2022/0058688 A1
(43) Pub. Date: Feb. 24, 2022

(54) METHODS AND APPARATUS TO DETERMINE CENSUS INFORMATION OF EVENTS

(71) Applicant: The Nielsen Company (US), LLC, New York, NY (US)

(72) Inventors: Michael Sheppard, Holland, MI (US); DongBo Cui, Fresh Meadows, NY (US); Jake Ryan Dailey, San Francisco, CA (US); Edward Murphy, North Stonington, CT (US); Diane Morovati Lopez, West Hills, CA (US)

(21) Appl. No.: 17/408,164

(22) Filed: Aug. 20, 2021

Related U.S. Application Data
(60) Provisional application No. 63/068,695, filed on Aug. 21, 2020.

(51) Int. Cl. G06Q 30/02; G06F 7/544

(52) U.S. Cl. CPC G06Q 30/0245; G06F 7/544

(57) ABSTRACT

Methods and apparatus to determine census information of events. An example apparatus includes an apparatus comprising a universe estimate calculator to determine an auxiliary equation based on census data corresponding to a first event and a second event, a constraint equation controller to select a first constraint equation and a second constraint equation based on the census data, the first constraint equation corresponding to the first event, the second constraint equation corresponding to the second event, a census information generator to determine first census information and second census information based on the auxiliary equation, the first constraint equation, the second constraint equation, panel data, and the census data, the first census information corresponding to the first event, the second census information corresponding to the second event, the first census information and the second census information not included in the census data, and a report generator to generate a report including the first census information and the second census information.

### RELATED APPLICATION

This patent claims the benefit of U.S. Provisional Patent Application Ser. No. 63/068,695, which was filed on Aug. 21, 2020. U.S. Provisional Patent Application No. 63/068,695 is hereby incorporated herein by reference in its entirety. Priority to U.S. Provisional Patent Application No. 63/068,695 is hereby claimed.

### FIELD OF THE DISCLOSURE

This disclosure relates generally to audience measurement, and, more particularly, to performing audience measurement based on methods and apparatus to determine census information of events.

### BACKGROUND

Tracking user access to media has been used by broadcasters and advertisers to determine viewership information for the media. Tracking viewership of media can present useful information to broadcasters and advertisers when determining placement strategies for digital advertising. The success of advertisement placement strategies is dependent on the accuracy that technology can achieve in generating audience metrics.

### BRIEF DESCRIPTION OF DRAWINGS

FIG. 1 illustrates an example audience estimate controller for estimating census information in accordance with teachings of this disclosure.

FIG. 2 illustrates example network-based logging techniques.

FIG. 3 is a block diagram of the example census estimate controller of FIGS. 1 and/or 2.

FIG. 4A is a first example table showing example panel audience sizes, example panel impression counts, example panel event durations, example census impression counts, and example census event durations.

FIG. 4B is a second example table showing the example panel audience sizes, the example panel impression counts, the panel event durations, the census impression counts, and the census event durations of FIG. 4A and example census audience sizes determined in accordance with teachings of this disclosure.

FIG. 5 is a flowchart representative of example machine readable instructions which may be executed to implement the example census estimate controller of FIGS. 1, 2, and/or 3 to estimate census information not included in census data for multiple events.

FIG. 6 is a block diagram of an example processing platform including processor circuitry structured to execute the example machine readable instructions of FIG. 5 to implement the census estimate controller of FIGS. 1, 2, and/or 3.

FIG. 7 is a block diagram of an example implementation of the processor circuitry of FIG. 6.

FIG. 8 is a block diagram of another example implementation of the processor circuitry of FIG. 6.

FIG. 9 is a block diagram of an example software distribution platform (e.g., one or more servers) to distribute software (e.g., software corresponding to the example machine readable instructions of FIG. 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second.

### DETAILED DESCRIPTION

Techniques for monitoring user access to an Internet-accessible media, such as digital television (DTV) media, digital advertisement ratings (DAR), and digital content ratings (DCR) media, have evolved significantly over the years. Internet-accessible media is also known as digital media. In the past, such monitoring was done primarily through server logs. In particular, entities serving media on the Internet would log the number of requests received for their media at their servers. Basing Internet usage research on server logs is problematic for several reasons. For example, server logs can be tampered with either directly or via zombie programs, which repeatedly request media from the server to increase the server log counts. Also, media is sometimes retrieved once, cached locally and then repeatedly accessed from the local cache without involving the server. Server logs cannot track such repeat views of cached media. Thus, server logs are susceptible to both over-counting and under-counting errors.

The inventions disclosed in Blumenau, U.S. Pat. No. 6,108,637, which is hereby incorporated herein by reference in its entirety, fundamentally changed the way Internet monitoring is performed and overcame the limitations of the server-side log monitoring techniques described above. For example, Blumenau disclosed a technique wherein Internet media to be tracked is tagged with monitoring instructions. In particular, monitoring instructions are associated with the hypertext markup language (HTML) of the media to be tracked. When a client requests the media, both the media and the monitoring instructions are downloaded to the client. The monitoring instructions are, thus, executed whenever the media is accessed, be it from a server or from a cache. Upon execution, the monitoring instructions cause the client to send or transmit monitoring information from the client to a content provider site. The monitoring information is indicative of the manner in which content was displayed.

In some implementations, an impression request or ping request can be used to send or transmit monitoring information by a client device using a network communication in the form of a hypertext transfer protocol (HTTP) request. In this manner, the impression request or ping request reports the occurrence of a media impression at the client device. For example, the impression request or ping request includes information to report access to a particular item of media (e.g., an advertisement, a webpage, an image, video, and audio). In some examples, the impression request or ping request can also include a cookie previously set in the browser of the client device that may be used to identify a user that accessed the media. That is, impression requests or ping requests cause monitoring data reflecting information about an access to the media to be sent from the client device that downloaded the media to a monitoring entity and can provide a cookie to identify the client device and/or a user of the client device. In some examples, the monitoring entity is an audience measurement entity (AME) that did not provide the media to the client and who is a trusted (e.g., neutral) third party for providing accurate usage statistics (e.g., The Nielsen Company, LLC). Because the AME is a third party relative to the entity serving the media to the client device, the cookie sent to the AME in the impression request to report the occurrence of the media impression at the client device is a third-party cookie. Third-party cookie tracking is used by measurement entities to track access to media accessed by client devices from first-party media servers.

There are many database proprietors operating on the Internet. These database proprietors provide services to large numbers of subscribers. In exchange for the provision of services, the subscribers register with the database proprietors. Examples of such database proprietors include social network sites (e.g., Facebook, Twitter, and MySpace), multi-service sites (e.g., Yahoo!, Google, Axiom, and Catalina), online retailer sites (e.g., Amazon.com and Buy.com), credit reporting sites (e.g., Experian), streaming media sites (e.g., YouTube and Hulu), etc. These database proprietors set cookies and/or other device/user identifiers on the client devices of their subscribers to enable the database proprietors to recognize their subscribers when they visit their web sites.

The protocols of the Internet make cookies inaccessible outside of the domain (e.g., Internet domain, and domain name) on which they were set. Thus, a cookie set in, for example, the facebook.com domain (e.g., a first party) is accessible to servers in the facebook.com domain, but not to servers outside that domain. Therefore, although an AME (e.g., a third party) might find it advantageous to access the cookies set by the database proprietors, they are unable to do so.

The inventions disclosed in Mazumdar et al., U.S. Pat. No. 8,370,489, which is incorporated by reference herein in its entirety, enable an AME to leverage the existing databases of database proprietors to collect more extensive Internet usage by extending the impression request process to encompass partnered database proprietors and by using such partners as interim data collectors. The inventions disclosed in Mazumdar accomplish this task by structuring the AME to respond to impression requests from clients (who may not be a member of an audience measurement panel and, thus, may be unknown to the AME) by redirecting the clients from the AME to a database proprietor, such as a social network site partnered with the AME, using an impression response. Such a redirection initiates a communication session between the client accessing the tagged media and the database proprietor. For example, the impression response received at the client device from the AME may cause the client device to send a second impression request to the database proprietor. In response to the database proprietor receiving this impression request from the client device, the database proprietor (e.g., Facebook) can access any cookie it has set on the client to thereby identify the client based on the internal records of the database proprietor. In cases where the client device corresponds to a subscriber of the database proprietor, the database proprietor logs/records a database proprietor demographic impression in association with the user/client device.

As used herein, an impression is defined to be an occurrence in which a home or individual accesses and/or is exposed to media (e.g., an advertisement, content, a group of advertisements, and/or a collection of content). In Internet media delivery, a quantity of impressions or impression count is the total number of times media (e.g., content, an advertisement, or advertisement campaign) has been accessed by a web population or audience members (e.g., the number of times the media is accessed). In some examples, an impression or media impression is logged by an impression collection entity (e.g., an AME or a database proprietor) in response to an impression request from a user/client device that requested the media. For example, an impression request is a message or communication (e.g., an HTTP request) sent by a client device to an impression collection server to report the occurrence of a media impression at the client device. In some examples, a media impression is not associated with demographics. In non-Internet media delivery, such as television (TV) media, a television or a device attached to the television (e.g., a set-top-box or other media monitoring device) may monitor media being output by the television. The monitoring generates a log of impressions associated with the media displayed on the television. The television and/or connected device may transmit impression logs to the impression collection entity to log the media impressions.

A user of a computing device (e.g., a mobile device, a tablet, and a laptop) and/or a television may be exposed to the same media via multiple devices (e.g., two or more of a mobile device, a tablet, and a laptop) and/or via multiple media types (e.g., digital media available online, digital TV (DTV) media temporality available online after broadcast, and TV media). For example, a user may start watching the Walking Dead television program on a television as part of TV media, pause the program, and continue to watch the program on a tablet as part of DTV media. In such an example, the exposure to the program may be logged by an AME twice: once for an impression log associated with the television exposure; and once for the impression request generated by a tag (e.g., census measurement science (CMS) tag) executed on the tablet. Multiple logged impressions associated with the same program and/or same user are defined as duplicate impressions. Duplicate impressions are problematic in determining total reach estimates because one exposure via two or more cross-platform devices may be counted as two or more unique audience members. As used herein, reach is a measure indicative of the demographic coverage achieved by media (e.g., demographic group(s) and/or demographic population(s) exposed to the media). For example, media reaching a broader demographic base will have a larger reach than media that reached a more limited demographic base. The reach metric may be measured by tracking impressions for known users (e.g., panelists) for which an AME stores demographic information and/or unknown users (e.g., non-panelists or census audience) for which the AME may be able to estimate and/or obtain demographic information. Deduplication is a process that is necessary to adjust cross-platform media exposure totals by reducing (e.g., eliminating) the double counting of individual audience members that were exposed to media via more than one platform and/or are represented in more than one database of media impressions used to determine the reach of the media.

As used herein, a unique audience is based on audience members distinguishable from one another. That is, a particular audience member exposed to particular media is measured as a single unique audience member regardless of how many times that audience member is exposed to that particular media or the particular platform(s) through which the audience member is exposed to the media. If that particular audience member is exposed multiple times to the same media, the multiple exposures for the particular audience member to the same media is counted as only a single unique audience member. As used herein, an audience size is a quantity of unique audience members of particular events (e.g., exposed to particular media.). That is, an audience size is a number of deduplicated or unique audience members exposed to a media item of interest of audience metrics analysis. A deduplicated or unique audience member is one that is counted only once as part of an audience size. Thus, regardless of whether a particular person is detected as accessing a media item once or multiple times, that person is only counted once as the audience size for that media item. In this manner, impression performance for particular media is not disproportionately represented when a small subset of one or more audience members is exposed to the same media an excessively large number of times while a larger number of audience members is exposed fewer times or not at all to that same media. Audience size may also be referred to as unique audience or deduplicated audience. By tracking exposures to unique audience members, a unique audience measure may be used to determine a reach measure to identify how many unique audience members are reached by media. In some examples, increasing unique audience and, thus, reach, is useful for advertisers wishing to reach a larger audience base.

In examples disclosed herein, the term duration corresponds to an aggregate or total of the individual exposure times associated with impressions during a monitoring interval. For example, the aggregation or total can be at the individual level such that a duration is associated with an individual, the aggregation or total can be at the demographic level such that the duration is associated with a given demographic, the aggregation or total can be at the population level such that the duration is associated with a given population universe, etc. In disclosed examples, the durations have continuous time units. The durations scale with a change in units of time, but both audience and impressions are invariant to that change.

Notably, although third-party cookies are useful for third-party measurement entities in many of the above-described techniques to track media accesses and to leverage demographic information from third-party database proprietors, use of third-party cookies may be limited or may cease in some or all online markets. That is, use of third-party cookies enables sharing anonymous subscriber information (without revealing personally identifiable information (PII)) across entities which can be used to identify and deduplicate audience members across database proprietor impression data. However, to reduce or eliminate the possibility of revealing user identities outside database proprietors by such anonymous data sharing across entities, some websites, internet domains, and/or web browsers will stop (or have already stopped) supporting third-party cookies. This will make it more challenging for third-party measurement entities to track media accesses via first-party servers. That is, although first-party cookies will still be supported and useful for media providers to track accesses to media via their own first-party servers, neutral third parties interested in generating neutral, unbiased audience metrics data will not have access to the impression data collected by the first-party servers using first-party cookies. Examples disclosed herein may be implemented with or without the availability of third-party cookies because, as mentioned above, the datasets used in the deduplication process are generated and provided by database proprietors, which may employ first-party cookies to track media impressions from which the datasets are generated.

In some examples, an AME tracks panel data including impression counts of panelists (e.g., panel impression counts), audience sizes of panelists (e.g., panel audience sizes), and event durations of panelists (e.g., panel event durations) across multiple events. In one example, the events are videos (e.g., video1, video2, video3). As a result, a panel impression count, a panel audience size, and a panel event duration are collected for each of the videos. Further, a total audience size of panelists (e.g., total panel audience size) is tracked by the AME. That is, an AME can track panel impression counts and corresponding panel audience sizes of the impression counts of an event. For example, an AME can monitor a home, such as a “Nielsen family,” that has been statistically selected to develop media (e.g., television) ratings data for a population/demographic of interest. The monitored home can include panelists that have been statistically selected to develop media ratings data (e.g., television ratings data) for a population/demographic of interest. People become panelists via, for example, a user interface presented on a media device. People become panelists in additional or alternative manners such as, for example, via a telephone interview, by completing an online survey, etc. Additionally or alternatively, people may be contacted and/or enlisted using any desired methodology (e.g., random selection, statistical selection, phone solicitations, Internet advertisements, surveys, advertisements in shopping malls, and product packaging). In some examples, an entire family may be enrolled as a household of panelists. That is, while a mother, a father, a son, and a daughter may each be identified as individual panelists, their viewing activities typically occur within the family's household.

In examples disclosed herein, panelists of the household have registered with an AME (e.g., by agreeing to be a panelist) and have provided their demographic information to the AME as part of a registration process to enable associating demographics with media exposure activities (e.g., television exposure, radio exposure, and Internet exposure). The demographic data includes, for example, age, gender, income level, educational level, marital status, geographic location, race, etc., of a panelist. In some examples, the example media presentation environment is a household. The example media presentation environment can additionally or alternatively be any other type(s) of environments such as, for example, a theater, a restaurant, a tavern, a retail location, an arena, etc.

In some examples, an AME additionally tracks census data including impression counts of unknown users (e.g., census impression counts), audience sizes of the unknown users (e.g., census audience sizes), and event durations of the unknown users (e.g., census event durations) across multiple events. In one example, the multiple events are videos (e.g., video1, video2, and video3). As a result, a census impression count, a census audience size, and a census event duration are collected for each of the videos. Further, a total census audience size of unknown users (e.g., total census audience size) is collected by the AME. As used herein, an impression for an unknown user (e.g., a census impression) is an impression that is logged for an access to media by a user for which demographic information is unknown. Thus, a census impression is indicative of an access to media but not indicative of the audience member to which the access should be attributed. As such, census impressions are logged as anonymous accesses to media by an AME to generate impression counts for media.

In some examples, census data determined by an entity (e.g., an AME) may only include partial census information. Undetermined census information (e.g., census information not included in the determined census data) may include census impression counts, census audience sizes, census term durations, or the total census audience size. In one example, because the census impressions are anonymous, they are not directly indicative of total unique audience sizes because multiple census impression counts may be attributed to the same person (e.g., the same person visits the same website multiple times and/or visits multiple different websites that present the same advertisement, and each presentation of that advertisement is reported as a separate impression, albeit for the same person). For example, an AME obtains impression counts from database proprietors. However, as described above, census impression counts lack demographic information and/or user identification. Thus, while an AME can determine census impression counts of a census audience, the total census audience size, and the census term durations, the AME may not be able to determine census audience sizes across multiple events.

As used herein, a total audience (e.g., the total panel audience size and the total census audience size) for media is a total number of unique persons that accessed the media in a particular geographic scope of interests for audience metrics, via one or more websites/webpages, via one or more internet domains, and/or during a duration of interest for audience metrics. Example geographic scopes of interest could be a city, a metropolitan area, a state, a country, etc. That is, the AME may not be able to determine the corresponding unique audience of the census impression counts. This makes reach difficult to measure on the census.

Examples disclosed herein estimate undetermined census information that has multiple dimensions. The multiple dimensions correspond to multiple events such as, for example, videos (e.g., video 1, video2, and video3). The undetermined census information is estimated based on determined census data and panel data. In disclosed examples, the durations have continuous time units. The durations scale with a change in units of time, but both audience and impressions are invariant to that change. The undetermined census information estimates may be produced by variables stored in a memory. Storing the variables, rather than every possible combination across the events, reduces the amount of memory needed to store the variables.

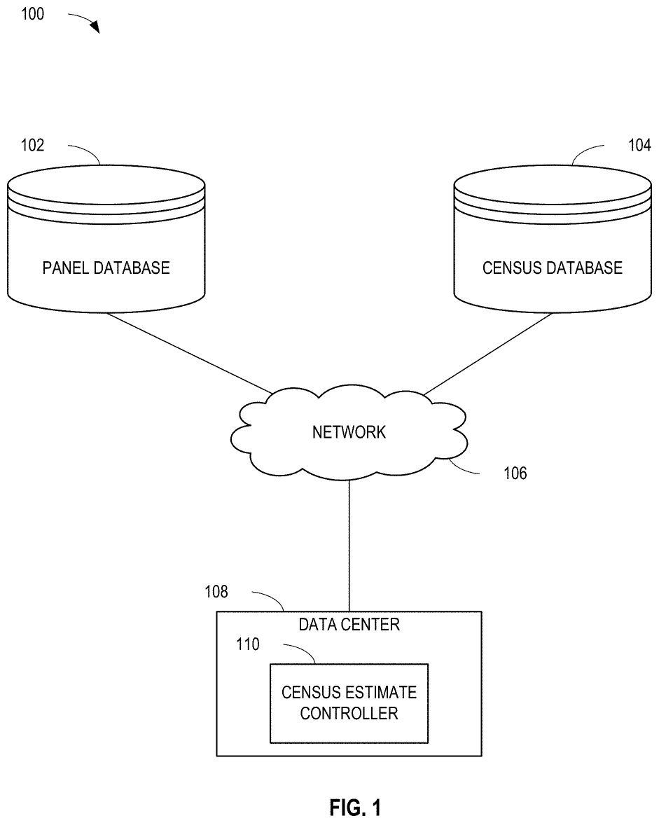

FIG. 1 illustrates an example audience estimation system 100 for estimating undetermined census information in accordance with teachings of this disclosure. The example audience estimation system 100 includes an example panel database 102, an example census database 104, an example network 106, and an example data center 108 that implements an example census estimate controller 110 to estimate audience size. The example data center 108 may be owned and/or operated by an AME, a database proprietor, a media provider, etc.

As used herein, a media impression is defined as an occurrence of access and/or exposure to media (e.g., an advertisement, a movie, a movie trailer, a song, a web page banner, and a webpage). Examples disclosed herein may be used to monitor for media impressions of any one or more media types (e.g., video, audio, a webpage, an image, and text). In examples disclosed herein, media may be content and/or advertisements. Examples disclosed herein are not restricted for use with any particular type of media. On the contrary, examples disclosed herein may be implemented in connection with tracking impressions for media of any type or form.

In the illustrated example of FIG. 1, the panel database 102 stores panelist data obtained by an AME using panel meters located at panelist households or other panelist metering sites. For example, the panelist data can include monitoring data representative of media content exposed to a panelist. A panelist is a person that has enrolled in an audience panel of an entity such as an AME, a database proprietor, and/or any other entity. The person enrolls in the panel by providing personally identifiable information (PII) (e.g., name, demographics, and address) and agreeing to have their media access activities monitored. The panel database 102 stores panel data including a total panel audience size, panel audience sizes, panel impression counts, and panel event durations. In some examples, the panel database 102 stores panel data corresponding to multiple events. For example, the panel database 102 stores a panel event duration, a panel impression count, and a panel audience size for a first website; a panel event duration, a panel impression count, and a panel audience size for a second website; etc.

The example census database 104 of the illustrated example of FIG. 1 stores census data determined by an AME. For example, the census database 104 can include impression-related data collected from devices not identifiable as belonging to panelists. As such, these impressions are referred to as census impressions collected as anonymous impressions for which a collecting entity (e.g., an AME and a database proprietor) does not have demographic information. In some examples, the data stored in the census database 104 includes data from a relatively larger sample size compared to the panel data stored in the panel database 102. The determined census data may only include partial census information. Undetermined census information (e.g., census impression counts, census audience sizes, census term durations, or the total census audience size) is not included in the determined census data. In some examples, the census database 104 stores determined census data including census impression counts, the total census audience size, and census event durations. The census database 104 may store census event durations corresponding to multiple events. For example, the census database 104 stores a total census audience size; a census impression count and a census event duration for a first website; a census impression count and a census event duration for a second website; etc. The determined census data is partial census information because the determined census data does not include census audience sizes corresponding to the multiple events.

The example network 106 of the illustrated example of FIG. 1 is a wide area network (WAN) such as the Internet. However, in some examples, local networks may additionally or alternatively be used. Moreover, the example network 106 may be implemented using any type of public or private network, such as, but not limited to, the Internet, a telephone network, a local area network (LAN), a cable network, and/or a wireless network, or any combination thereof.

In the illustrated example of FIG. 1, the data center 108 communicates with the panel database 102 and the census database 104 through the network 106. In some examples, the data center 108 contains the census estimate controller 110. In the illustrated example of FIG. 1, the data center 108 is an execution environment used to implement the census estimate controller 110. In some examples, the data center 108 is associated with a media monitoring entity (e.g., an AME). In some examples, the data center 108 can be a physical processing center (e.g., a central facility of the media monitoring entity). Additionally or alternatively, the data center 108 can be implemented via a cloud service (e.g., Amazon Web Services (AWS)). In this example, the data center 108 can further store and process panel data and determined census data.

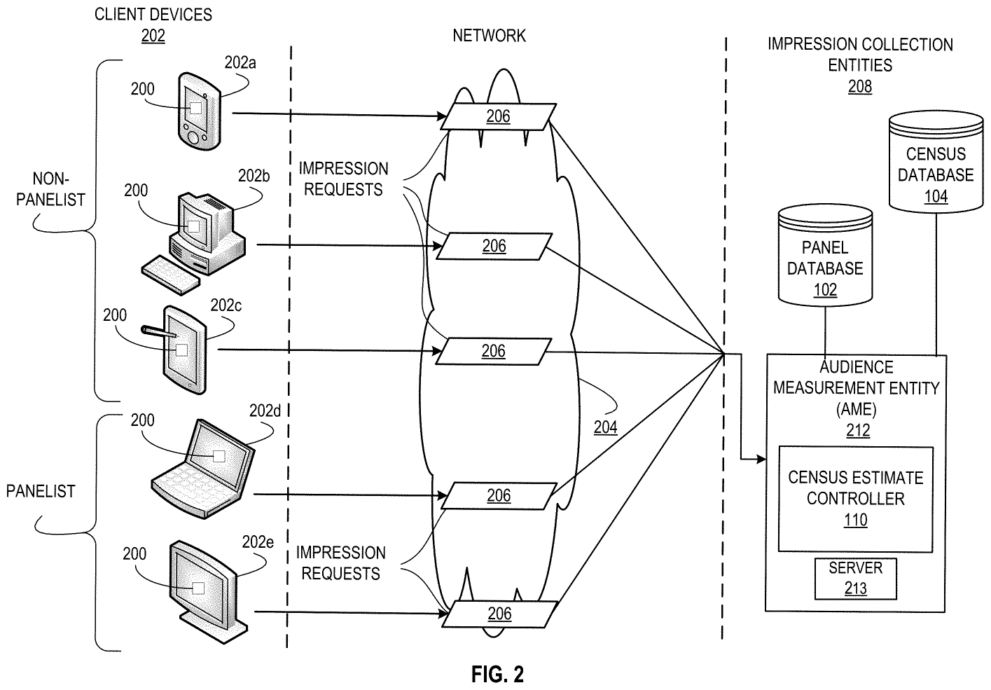

The example census estimate controller 110 of the illustrated example of FIG. 1 estimates undetermined census information not included in the determined census data. In some examples, the census estimate controller 110 accesses and obtains panel data from the panel database 102 (e.g., total panel audience size, panel event durations, panel impression counts, and panel audience sizes) and determined census data from the census database 104 (e.g., total census audience size, census event durations, census impression counts, and/or census audience sizes). The census estimate controller 110 determines the undetermined census information based on the panel data and the determined census data. The example census estimate controller 110 is described below in connection with FIG. 2. In some examples, the census estimate controller 110 is an application-specific integrated circuit (ASIC), and in some examples the census estimate controller 110 is a field programmable gate array (FPGA). Alternatively, the census estimate controller 110 can be software located in the firmware of the data center 108.

FIG. 2 illustrates example network-based impression logging techniques. Such example techniques may be used to collect the panel impression information in the panel database 102 and the census impression information in the census database 104. FIG. 2 illustrates example client devices 202 that report audience impression requests for Internet-based media 200 to impression collection entities 208 to identify a unique audience and/or a frequency distribution for the Internet-based media. The illustrated example of FIG. 2 includes the example client devices 202, an example network 204, example impression requests 206, and the example impression collection entities 208. As used herein, an impression collection entity 208 refers to any entity that collects impression data such as, for example, an example AME 212. Although only the AME 212 is shown, other impression collection entities may also collect impressions. In the illustrated example, the AME 212 logs panel impressions in the panel database 102 and logs census impressions in the census database 104. In other examples, one or more other impression collection entities in addition to or instead of the AME 212 may log impressions and/or durations for one or both of the panel database 102 and the census database 104. In some examples, a server 213 of the AME 212 logs census impressions in the census database 104 and another server of a database proprietor (separate from the AME 212) logs panel impressions in the panel database 102 based on its subscribers. In such examples, subscribers of the database proprietor operate the panelist client devices 202d and 202e such that the database proprietor recognizes the panelist client devices 202d, 202e as operated by its subscribers based on information (e.g., first-party cookies) in the impression requests 206 from the panelist client devices 202d, 202e. In the illustrated example, the AME 212 includes the example census estimate controller 110 of FIG. 1.

The example client devices 202 of the illustrated example may be any device capable of accessing media over a network (e.g., the example network 204). For example, the client devices 202 may be an example mobile device 202a, an example computer 202b, 202d, an example tablet 202c, an example smart television 202e, and/or any other Internet-capable device or appliance. Examples disclosed herein may be used to collect impression information for any type of media including content and/or advertisements. Media may include advertising and/or content delivered via websites, streaming video, streaming audio, Internet protocol television (IPTV), movies, television, radio and/or any other vehicle for delivering media. In some examples, media includes user-generated media that is, for example, uploaded to media upload sites, such as YouTube, and subsequently downloaded and/or streamed by one or more other client devices for playback. Media may also include advertisements. Advertisements are typically distributed with content (e.g., programming, on-demand video and/or audio). Traditionally, content is provided at little or no cost to the audience because it is subsidized by advertisers that pay to have their advertisements distributed with the content. As used herein, “media” refers collectively and/or individually to content and/or advertisement(s).

The example network 204 is a communications network. The example network 204 allows the example impression requests 206 from the example client devices 202 to the example impression collection entities 208. The example network 204 may be a local area network, a wide area network, the Internet, a cloud, or any other type of communications network.

The impression requests 206 of the illustrated example include information about accesses to media at the corresponding client devices 202 generating the impression requests. Such impression requests 206 allow monitoring entities, such as the impression collection entities 208, to collect a number of and/or duration of media impressions for different media accessed via the client devices 202. By collecting media impressions, the impression collection entities 208 can generate media impression counts for different media (e.g., different content and/or advertisement campaigns).

The impression collection entities 208 of the illustrated example include the example panel database 102, the example census database 104, and the example AME 212. In some examples, execution of the beacon instructions corresponding to the media 200 causes the client devices 202 to send impression requests 206 to server 213 (e.g., accessible via an Internet protocol (IP) address or uniform resource locator (URL)) of the impression collection entities 208 in the impression requests 206. In some examples, the beacon instructions cause the client devices 202 to provide device and/or user identifiers and media identifiers in the impression requests 206. The device/user identifier may be any identifier used to associate demographic information with a user or users of the client devices 202. Example device/user identifiers include cookies, hardware identifiers (e.g., an international mobile equipment identity (IMEI), a mobile equipment identifier (MEID), a media access control (MAC) address, etc.), an app store identifier (e.g., a Google Android ID, an Apple ID, and an Amazon ID), an open source unique device identifier (OpenUDID), an open device identification number (ODIN), a login identifier (e.g., a username), an email address, user agent data (e.g., application type, operating system, software vendor, and software revision), an Ad ID (e.g., an advertising ID introduced by Apple, Inc. for uniquely identifying mobile devices for purposes of serving advertising to such mobile devices), third-party service identifiers (e.g., advertising service identifiers, device usage analytics service identifiers, and demographics collection service identifiers), etc. In some examples, fewer or more device/user identifier(s) may be used. The media identifiers (e.g., embedded identifiers, embedded codes, embedded information, and signatures) enable the impression collection entities 208 to identify media (e.g., the media 200) objects accessed via the client devices 202. The impression requests 206 of the illustrated example cause the AME 212 to log impressions for the media 200. In the illustrated example, an impression request is a reporting to the AME 212 of an occurrence of the media 200 being presented at the client device 202. The impression requests 206 may be implemented as a hypertext transfer protocol (HTTP) request. However, whereas a transmitted HTTP request identifies a webpage or other resource to be downloaded, the impression requests 206 include audience measurement information (e.g., media identifiers and device/user identifier) as its payload. The server 213 to which the impression requests 206 are directed is programmed to log the audience measurement information of the impression requests 206 as an impression (e.g., a media impression such as advertisement and/or content impressions depending on the nature of the media accessed via the client device 202). In some examples, the server 213 of the AME 212 may transmit a response based on receiving an impression request 206. However, a response to the impression request 206 is not necessary. It is sufficient for the server 213 to receive the impression request 206 to log an impression request 206. As such, in examples disclosed herein, the impression request 206 is a dummy HTTP request for the purpose of reporting an impression but to which a receiving server need not respond to the originating client device 202 of the impression request 206.

In the illustrated example, the example AME 212 does not provide the media 200 to the client devices 202 and is a trusted (e.g., neutral) third party (e.g., The Nielsen Company, LLC) for providing accurate media access (e.g., exposure) statistics. The example AME 212 includes the example census estimate controller 110. As further disclosed herein, the example census estimate controller 110 estimates undetermined census information based on the example impression requests 206. The example census estimate controller 110 is described in connection with FIGS. 1 and/or 3.

In operation, the example client devices 202 employ web browsers and/or applications (e.g., apps) to access media. Some of the web browsers, applications, and/or media include instructions that cause the example client devices 202 to report media monitoring information to one or more of the example impression collection entities 208. That is, when the client device 202 of the illustrated example accesses media, a web browser and/or application of the client device 202 executes instructions in the media, in the web browser, and/or in the application to send the example impression request 206 to one or more of the example impression collection entities 208 via the network (e.g., a local area network, wide area network, wireless network, cellular network, the Internet, and/or any other type of network). The example impression requests 206 of the illustrated example include information about accesses to the media 200 and/or any other media at the corresponding client devices 202 generating the impression requests 206. Such impression requests allow monitoring entities, such as the example impression collection entities 208, to collect media impressions for different media accessed via the example client devices 202. In this manner, the impression collection entities 208 can generate media impression counts for different media (e.g., different content and/or advertisement campaigns).

The example AME 212 accesses panel data in the example panel database 102 and/or determined census data in the example census database 104. The panel data includes information related to a total number of the logged impressions and/or any other information related to the logged impressions (e.g., durations, demographics, a total number of registered users exposed to the media 200 more than once) that corresponds to registered panelists. The determined census data includes information related to logged impressions and/or any other impression-related information that corresponds to non-panelist audience members. The example census estimate controller 110 estimates undetermined census information (e.g., census information not included in the determined census data) based on impression requests 206 in accordance with teachings of this disclosure.

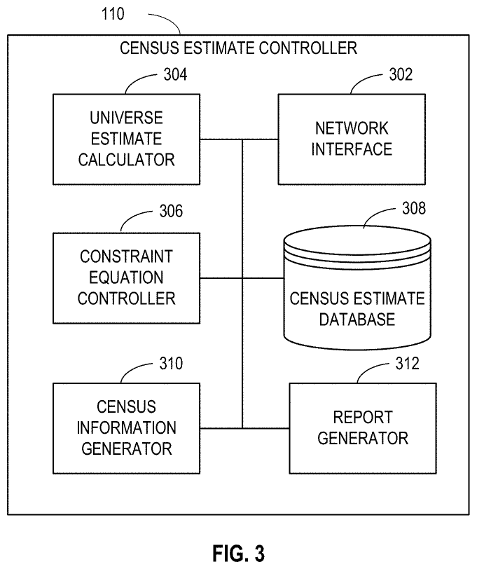

FIG. 3 is a block diagram of the example census estimate controller 110 of FIGS. 1 and/or 2. The example census estimate controller 110 includes an example network interface 302, an example universe estimate calculator 304, an example constraint equation controller 306, an example census estimate database 308, an example census information generator 310, and an example report generator 312.

The example network interface 302 of the illustrated example of FIG. 3 allows the census estimate controller 110 to receive panel data and/or determined census data from the example network 106 of FIG. 1. In some examples, the network interface 302 can be continuously connected to the network 106, the panel database 102, and/or the census database 104 for communication with the network 106, the panel database 102, and/or the census database 104. In other examples, the network interface 302 can be periodically or aperiodically connected for periodic or aperiodic communication with the network 106, the panel database 102, and/or the census database 104. In some examples, the network interface 302 can be absent.

The example universe estimate calculator 304 of the illustrated example of FIG. 3 determines pseudo-universe estimates for the panel data and for the determined census data. The example census information generator 310 determines the undetermined census information (e.g., census information not included in the determined census data) based on the pseudo-universe estimates.

For examples in which only audience sizes of events are considered (e.g., durations of events are not considered), there are n+2 constraints, where n is the number of events. That is, there are n constraints from each respective event audience (e.g., zⱼ j={1, . . . , n}, a constraint for total audience (e.g., z_{●}), and a constraint for total normalized audience to 100% (e.g., z₀). Each constraint has a Lagrange Multiplier, which can be expressed in multiplicative form in terms of the unknown variables as shown in example Equations 1a, 1b, and 1c.

$$\begin{matrix}{z}_{0} z . {z}_{j} {\prod }_{k = 1 \\ k \neq j}^{n} ( 1 + {z}_{j} ) = {A}_{j} \\ j = \{ 1 , 2 , … , n \} & ( Equation 1 a ) \\ {z}_{0} z . ( {\prod }_{k = 1}^{n} ( 1 + {z}_{j} ) - 1 ) = A . & ( Equation 1 b ) \\ {z}_{0} + {z}_{0} z . ( {\prod }_{k = 1}^{n} ( 1 + {z}_{j} ) - 1 ) = 1 & ( Equation 1 c )\end{matrix}$$

The variable Aⱼ is the proportion of people in the marginal audience of the j^{th} event such that the sum is normalized to 100% relative to the universe estimate, U. The variable A_{●} is the proportion of the total unique audience size such that the sum is normalized to 100% with respect to the universe estimate. For example, if U=200 (e.g., the universe estimate is 200 people) and Aⱼ=0.3 (e.g., the proportion of people in the audience of the j^{th} event is 30% of the universe estimate), then the audience size of the j^{th} event is 60 people.

Solving example Equations 1a-c for zⱼ, z_{●}, and z₀ produces example Equations 2a, 2b, and 2c below.

$$\begin{matrix}{z}_{j} = \frac{{A}_{j}}{Q - {A}_{j}} j = \{ 1 , 2 , … , n \} & ( Equation 2 a ) \\ z . = \frac{Q - A .}{1 - A .} & ( Equation 2 b ) \\ {z}_{0} = 1 - A . & ( Equation 2 c )\end{matrix}$$

The variable Q is the pseudo-universe estimate. That is, the variable Q is what the universe estimate, U would be to predict the panel data and determined census data assuming independence. Independence omits correlations between events.

Thus, Q can be solved for using example Equation 3 below.

$$1 - \frac{A .}{Q} = {\prod }_{j = 1}^{n} ( 1 - \frac{{A}_{j}}{Q} ) \qquad ( Equation 3 )$$

In examples disclosed herein, durations of events are considered in addition to the audience sizes of the events. As described above, an individual that is a member of an event (e.g., viewed a television show and accessed a webpage) corresponds to at least some duration of that event. For examples in which durations of events are considered, there are an additional 2n constraints, where n is the number of events. That is, there are 2n constraints from each respective event audience (e.g., zⱼ={1, . . . , n}). In cases where the total impressions and durations are known for each event, there may be an impression constraint and a duration constraint. The variable Rⱼ is the impression constraint for j={1, . . . , n} representing impressions for each event. The variable Dⱼ is the duration constraint for j={1, . . . , n} representing durations for each event. In examples disclosed herein, the audience size is normalized by the population (e.g., example Equation 1c). Thus, the durations are also normalized by the population. For example, the network interface 302 may receive data from the panel database 102 including a duration of 500 time units, a panel audience size of 20 people, and a total population of 50 people. In such an example, the audience constraint is 40% (e.g., 20/50=0.4) while the duration constraint is 10 (e.g., 500/50=10). In examples disclosed herein, the time units of the durations can be any suitable and/or arbitrary units. However, all durations must scale appropriately in the same direction. For example, estimates of audience sizes should be invariant to changes in the time units, while the estimates of duration should scale with the changes in the time units.

In examples disclosed herein, the panel database 102 and the census database 104 include durations for each event. That is, the panel database 102 includes a panel event duration for each event and the census database 104 includes a census impression count for each event. Thus, if zⱼ is the audience-only multiplier (e.g., audience size) and the set {zⱼ^{(a)}, zⱼ⁽ⁱ⁾, zⱼ^{(d)}} are multipliers for splitting the audience into different durations, an equality can be written as shown in Equation 4 below.

$${z}_{j} = {z}_{j}^{( a )} {\sum }_{k = 1}^{∞} {( {z}_{j}^{( i )} )}^{k} ( {\int }_{t = 0}^{∞} {( {z}_{j}^{( d )} )}^{t} dt ) = {z}_{j}^{( a )} ( \frac{{z}_{j}^{( i )}}{1 - {z}_{j}^{( i )}} ) ( \frac{- 1}{log ( {z}_{j}^{( d )} )} ) \qquad ( Equation 4 )$$

As described above, the variable zⱼ^{(a)} is the event audience constraint, zⱼ⁽ⁱ⁾ is the impressions constraint, and the variable zⱼ^{(d)} is the event duration constraint. That is, the left-hand side of example Equation 4 is the Lagrange Multiplier for the audience of j^{th} event. The right-hand side of example Equation 4 represents a partition, integrating across all continuous durations that belong to the j^{th} event. Thus, the information contained in the collection of the subsets of impressions is identical to only having access to audience-only information in this example.

The example Equation 2a (e.g., solving for zⱼ) can be substituted into Equation 4, producing Equation 5 below.

$$\frac{{A}_{j}}{Q - {A}_{j}} = {z}_{j}^{( a )} ( \frac{{z}_{j}^{( i )}}{1 - {z}_{j}^{( i )}} ) ( \frac{- 1}{log ( {z}_{j}^{( d )} )} ) \\ j = \{ 1 , 2 , … , n \} \qquad ( Equation 5 )$$

In cases where two of the three unknown variables on the right-hand side of Equation 5 are solved, the remaining unknown variable can be solved. The unknown variables zⱼ⁽ⁱ⁾ and zⱼ^{(d)} can be determined by noticing that their frequencies must match the observed Equations 6 and 7 below.

$$\begin{matrix}\frac{{R}_{j}}{{A}_{j}} = \frac{{\sum }_{k = 1}^{∞} {k ( {z}_{j}^{( i )} )}^{k}}{{\sum }_{k = 1}^{∞} {( {z}_{j}^{( i )} )}^{k}} = \frac{1}{1 - {z}_{j}^{( i )}} j = \{ 1 , 2 , … , n \} & ( Equation 6 ) \\ \frac{{D}_{j}}{{A}_{j}} = \frac{{\int }_{t = 0}^{∞} {t ( {z}_{j}^{( d )} )}^{t} d t}{{\int }_{t = 0}^{∞} {( {z}_{j}^{( d )} )}^{t} d t} = \frac{- 1}{log ( {z}_{j}^{( d )} )} j = \{ 1 , 2 , … , n \} & ( Equation 7 )\end{matrix}$$

Thus, zⱼ⁽ⁱ⁾ and zⱼ^{(d)} can be defined as shown in example Equation 7 below.

$$\begin{matrix}{z}_{j}^{( i )} = 1 - \frac{{A}_{j}}{{R}_{j}} & ( Equation 8 ) \\ {z}_{j}^{( d )} = exp ( - \frac{{A}_{j}}{{D}_{j}} ) & ( Euqation 9 )\end{matrix}$$

Further, zⱼ^{(a)} can be determined by substituting a value of zⱼ⁽ⁱ⁾ from Equation 8 and of zⱼ^{(d)} from Equation 9 into Equation 5 to produce example Equation 10 as shown below.

$${z}_{j}^{( a )} = \frac{{A}_{j}^{3}}{( Q - {A}_{j} ) ( {R}_{j} - {A}_{j} ) {D}_{j}} \qquad ( Equation 10 )$$

In summary, there are four equations of the model, shown in example Equations 11a, 11b, 11c, 11d, and 11 e below.

$$\begin{matrix}{z}_{0} z . {z}_{j} {\prod }_{k = 1 \\ k \neq j}^{n} ( 1 + {z}_{j} ) = {A}_{j} j = \{ 1 , 2 , … , n \} & ( Equation 11 a ) \\ ( \frac{1}{1 - {z}_{j}^{( i )}} ) {z}_{0} z . {z}_{i} {\prod }_{k = 1 \\ k \neq j}^{n} ( 1 + {z}_{j} ) = {R}_{j} \\ j = \{ 1 , 2 , … , n \} & ( Equation 11 b ) \\ ( \frac{- 1}{log ( {z}_{j}^{( d )} )} ) {z}_{0} z . {z}_{j} {\prod }_{k = 1 \\ k \neq j}^{n} ( 1 + {z}_{j} ) = {D}_{j} \\ j = \{ 1 , 2 , … , n \} & ( Equation 11 c ) \\ {z}_{0} z . ( {\prod }_{k = 1}^{n} ( 1 + {z}_{j} ) - 1 ) = A . & ( Equation 11 d ) \\ {z}_{0} + {z}_{0} z . ( {\prod }_{k = 1}^{n} ( 1 + {z}_{j} ) - 1 ) = 1 & ( Equation 11 e )\end{matrix}$$

The four equations are solved using Equation 12 below, where Equation 12 is based on Equation 4 above.

$${z}_{j} = {z}_{j}^{( a )} ( \frac{{z}_{j}^{( i )}}{1 - {z}_{j}^{( i )}} ) ( \frac{- 1}{log ( {z}_{j}^{( d )} )} ) \qquad ( Equation 12 )$$

Solving for the four constraints produces example Equations 13a, 13b, 13c, and 13d below.

$$\begin{matrix}{z}_{j}^{( a )} = \frac{{A}_{j}^{3}}{( Q - {A}_{j} ) ( {R}_{j} - {A}_{j} ) {D}_{j}} \\ j = \{ 1 , 2 , … , n \} & ( Equation 13 a ) \\ {z}_{j}^{( i )} = 1 - \frac{{A}_{j}}{{R}_{j}} j = \{ 1 , 2 , … , n \} & ( Equation 13 b ) \\ {z}_{j}^{( d )} = exp ( - \frac{{A}_{j}}{{D}_{j}} ) j = \{ 1 , 2 , … , n \} & ( Equation 13 c ) \\ z . = \frac{Q - A .}{1 - A .} & ( Equation 13 d ) \\ {z}_{0} = 1 - A . & ( Equation 13 e )\end{matrix}$$

Example Equation 12 below can be used to determine Q.

$$1 - \frac{A .}{Q} = {\prod }_{j = 1}^{n} ( 1 - \frac{{A}_{j}}{Q} ) \qquad ( Equation 14 )$$

That is, the example universe estimate calculator 304 can use example Equation 14 to determine the pseudo-universe estimate (e.g., Q). In some examples, the universe estimate calculator 304 can determine a panel pseudo-universe estimate (e.g., Q_{P}) corresponding to the panel data, and a census pseudo-universe estimate (e.g., Q_{C}) corresponding to the determined census data.

There are 3n+2 variables, where n is the number of events. That is, there are 3n variables from each respective event (e.g., zⱼ^{(a)} j={1, . . . , n}, zⱼ⁽ⁱ⁾ j={1, . . . , n}, and zⱼ^{(d)} j={1, . . . , n}), a variable for total audience (e.g., z_{●}), and a variable for total normalized audience to 100% (e.g., z₀). For example, the determined census data may include census impression counts, census event durations, and a total census audience. However, the undetermined census information (e.g., census information not included in the determined census data) may be census audience sizes for each of the events. The 3n+2 variables are utilized to reproduce the probability distribution of census audience sizes. An approach to estimate the undetermined census information is described below.

In examples disclosed herein, multipliers of the unknown constraints (e.g., the audience constraints, zⱼ^{(a)}) in the census data must equal the same multipliers for the panel data. This equality is illustrated in example Equation 15 below.

{zⱼ^{(a)}}_{P}={zⱼ^{(a)}}_{C} j={1,2, . . . ,n} (Equation 15)

That is, the set of unknowns, zⱼ^{(a)}, within the panel, P, must equal the same set of unknowns within the census, C. Thus, substituting example Equation 13a into example Equation 15 produces example Equation 16 below.

$$\frac{{A}_{j}^{3}}{( {Q}_{P} - {A}_{j} ) ( {R}_{j} - {A}_{j} ) {D}_{j}} = \frac{{X}_{j}^{3}}{( {Q}_{C} - {X}_{j} ) ( {T}_{j} - {X}_{j} ) {V}_{j}} \\ j = \{ 1 , 2 , … , n \} \qquad ( Equation 16 )$$

The variables {A, R, D} describe audience, impressions, and durations of the panel, respectively. The variables {X, T, V} describe audience, impressions and durations of the census, respectively.

The subscripts of the variable Q represent the two different populations (e.g., universe estimates): panel, P, and census, C. Using example Equation 16, Q_{P} can be solved as shown in example Equation 17 below.

$$1 - \frac{A .}{{Q}_{P}} = {\prod }_{j = 1}^{n} ( 1 - \frac{{A}_{j}}{{Q}_{P}} ) \qquad ( Equation 17 )$$

That is, the example network interface 302 receives values for A_{●} (e.g., the total panel audience size) and Aⱼ (e.g., the panel audience sizes for the j events) from the panel database 102 (FIG. 1). Thus, the example universe estimate calculator 304 can determine the value of Q_{P} using example Equation 17.

The example universe estimate calculator 304 can generate an auxiliary equation based on the determined census data. For example, the example network interface 302 receives values for X_{●} (e.g., the total census audience size), but does not receive values for Xⱼ (e.g., the census audience sizes for the j events) from the panel database 102. Using example Equation 14 and solving for Xⱼ produces a function of Xⱼ in terms of Q_{C}, illustrated in example Equation 18 below.

$$1 - \frac{X .}{{Q}_{C}} = {\prod }_{j = 1}^{n} ( 1 - \frac{{X}_{j}}{{Q}_{C}} ) \qquad ( Equation 18 )$$

Equation 18 is the auxiliary equation, where Xⱼ and Q_{C} are unknown variables. The census information generator 310 generates a system of equations including the auxiliary equation combined with constraint equations generated by the constraint equation controller 306, where the system of equations can be solved to determine the unknown variables Xⱼ and Q_{C}.

The example constraint equation controller 306 of the illustrated example of FIG. 3 selects the constraint equations used to solve for the undetermined census information. For example, for each event in the panel data and/or the census data, the constraint equation controller 306 selects a constraint equation corresponding to each event based on Equation 16 above. The constraint equation controller 306 can determine a value of the left-hand side of each constraint equation using known values of Q_{P}, Dⱼ, Rⱼ, and Aⱼ. The constraint equation controller 306 can further determine a value of the right-hand side of the example Equation 16, resulting in example Equation 19 below.

$$\# = \frac{{X}_{j}^{3}}{( {Q}_{C} - {X}_{j} ) ( {T}_{j} - {X}_{j} ) {V}_{j}} \qquad ( Equation 19 )$$

Wherein the symbol #is the numeric value of the right-hand side of example Equation 16. Thus, two unknown variables remain in example Equation 19 (e.g., the example network interface 302 receives values for census impression counts Tⱼ and census event durations Vⱼ).

The example census estimate database 308 of the illustrated example of FIG. 3 stores panel data and determined census data. For example, the census estimate database 308 stores panel impression counts, panel event durations, panel audience sizes, total panel audience size, census impression counts, census audience sizes, total census audience size, and/or census event durations received from the panel database 102 (FIG. 1) and the census database 104 (FIG. 1) via the network interface 302. The example census estimate database 308 can also store the estimated undetermined census information (e.g., census audience sizes) that is determined by the example census information generator 310. However, other data may additionally and/or alternatively be stored by the census estimate database 308. For example, the 3n+2 variables can be stored to the census estimate database 308 to reproduce any probability distribution. Storing 3n+2 variables, rather than 2n combinations of possible events for an audience viewership, reduces storage. The census estimate database 308 of the illustrated example of FIG. 3 is implemented by any memory, storage device, and/or storage disc for storing data such as, for example, flash memory, magnetic media, optical media, solid state memory, hard drive(s), thumb drive(s), etc. Furthermore, the data stored in the example census estimate database 308 may be in any format such as, for example, binary data, comma delimited data, tab delimitated data, structured query language (SQL) structures, etc. While, in the illustrated example of FIG. 3, the census estimate database 308 is illustrated as a single device, the census estimate database 308 and/or any other data storage devices described herein may be implemented by any number and/or type(s) of storage devices.

The example census information generator 310 of the illustrated example of FIG. 3 determines census audience sizes corresponding to each event based on the system of equations selected by the universe estimate calculator 304 and/or the constraint equation controller 306. For example, the system of equations includes one or more constraint equations corresponding to each event based on Equation 16, and an auxiliary equation based on Equation 17. The system of equations includes n+1 equations, where n is the number of events in the panel data and/or the census data. Furthermore, the system of equations includes n+1 unknown variables, including one or more variables Xⱼ corresponding to the census audience size for each event and a variable Q_{C} corresponding to a census pseudo-universe estimate. As such, the census information generator 310 solves the system of equations to determine values for the unknown variables Xⱼ and Q_{C}.

The example report generator 312 of the illustrated example of FIG. 3 generates an output including data stored in the example census estimate database 308. For example, the report generator 312 generates a report including census information corresponding to the undetermined census information that is determined by the census information generator 310. In one example, the census information includes census audience size for one or more events.

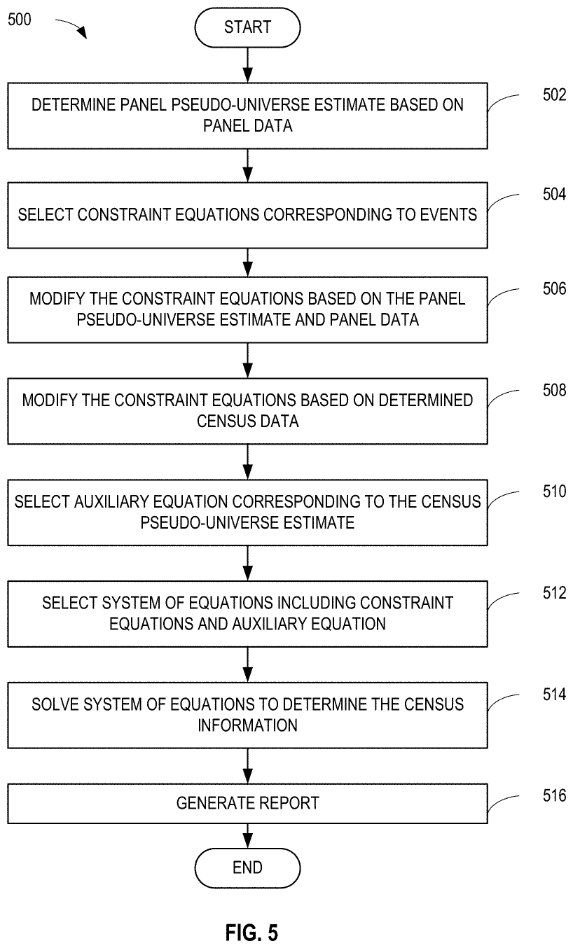

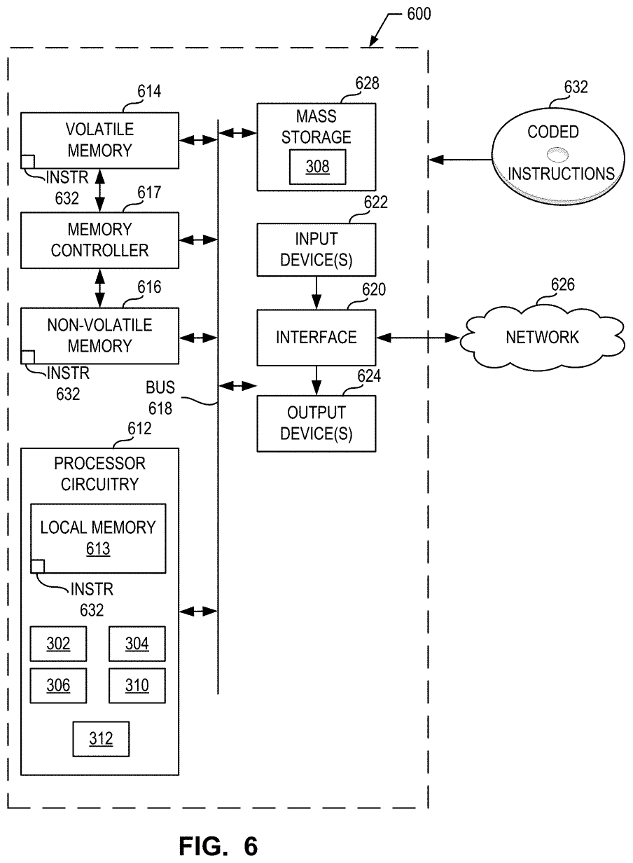

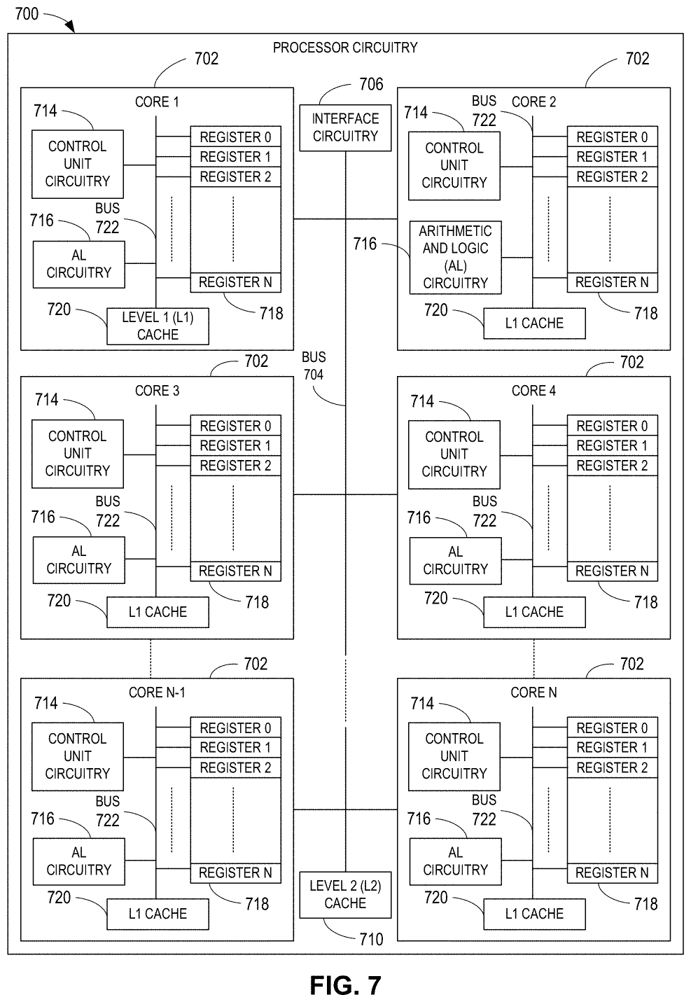

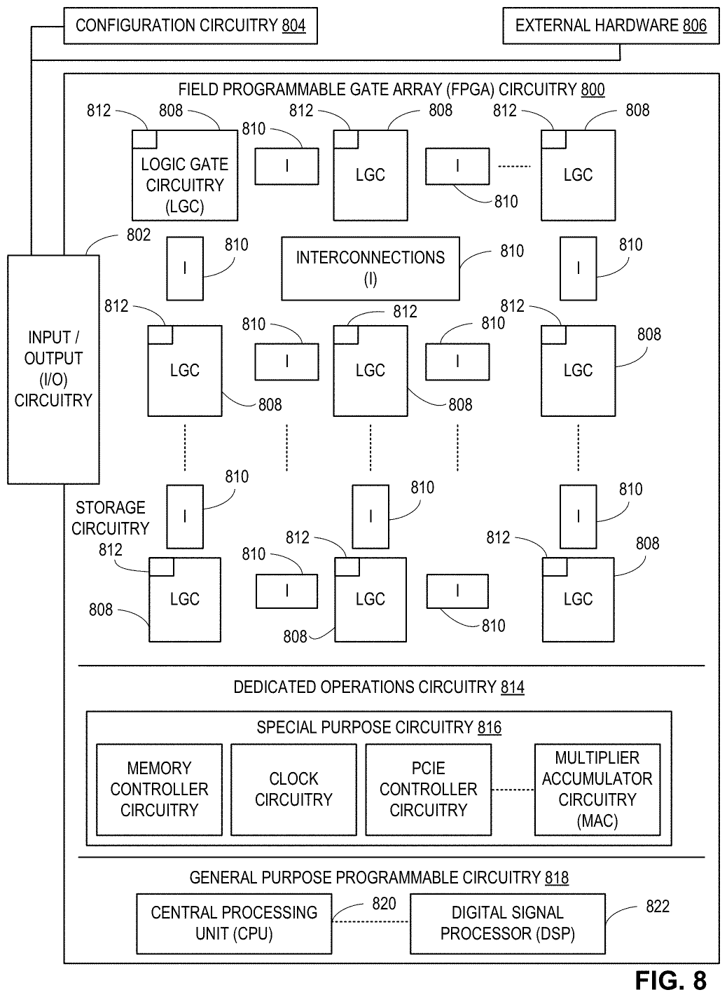

In some examples, the apparatus includes means for determining the undetermined census information. For example, the means for determining the undetermined census information may be implemented by the census estimate controller 110. In some examples, the census estimate controller 110 may be implemented by machine executable instructions such as that implemented by at least blocks 502, 504, 506, 508, 510, 512, 514, and 516 of FIG. 5 executed by processor circuitry, which may be implemented by the example processor circuitry 612 of FIG. 6, the example processor circuitry 700 of FIG. 7, and/or the example Field Programmable Gate Array (FPGA) circuitry 800 of FIG. 8. In other examples, the census estimate controller 110 is implemented by other hardware logic circuitry, hardware implemented state machines, and/or any other combination of hardware, software, and/or firmware. For example, the census estimate controller 110 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While an example manner of implementing the census estimate controller 110 of FIGS. 1 and 2 is illustrated in FIG. 3, one or more of the elements, processes, and/or devices illustrated in FIG. 3 may be combined, divided, re-arranged, omitted, eliminated, and/or implemented in any other way. Further, the example network interface 302, the example universe estimate calculator 304, the example constraint equation controller 306, the example census estimate database 308, the example census information generator 310, the example report generator 312 and/or, more generally, the example census estimate controller 110 of FIG. 3, may be implemented by hardware, software, firmware, and/or any combination of hardware, software, and/or firmware. Thus, for example, any of the example network interface 302, the example universe estimate calculator 304, the example constraint equation controller 306, the example census estimate database 308, the example census information generator 310, the example report generator 312 and/or, more generally, the example census estimate controller 110 of FIG. 3, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example network interface 302, the example universe estimate calculator 304, the example constraint equation controller 306, the example census estimate database 308, the example census information generator 310, and/or the example report generator 312 is/are hereby expressly defined to include a non-transitory computer readable storage device or storage disk such as a memory, a digital versatile disk (DVD), a compact disk (CD), a Blu-ray disk, etc., including the software and/or firmware. Further still, census estimate controller 110 of FIG. 3 may include one or more elements, processes, and/or devices in addition to, or instead of, those illustrated in FIG. 3, and/or may include more than one of any or all of the illustrated elements, processes and devices.

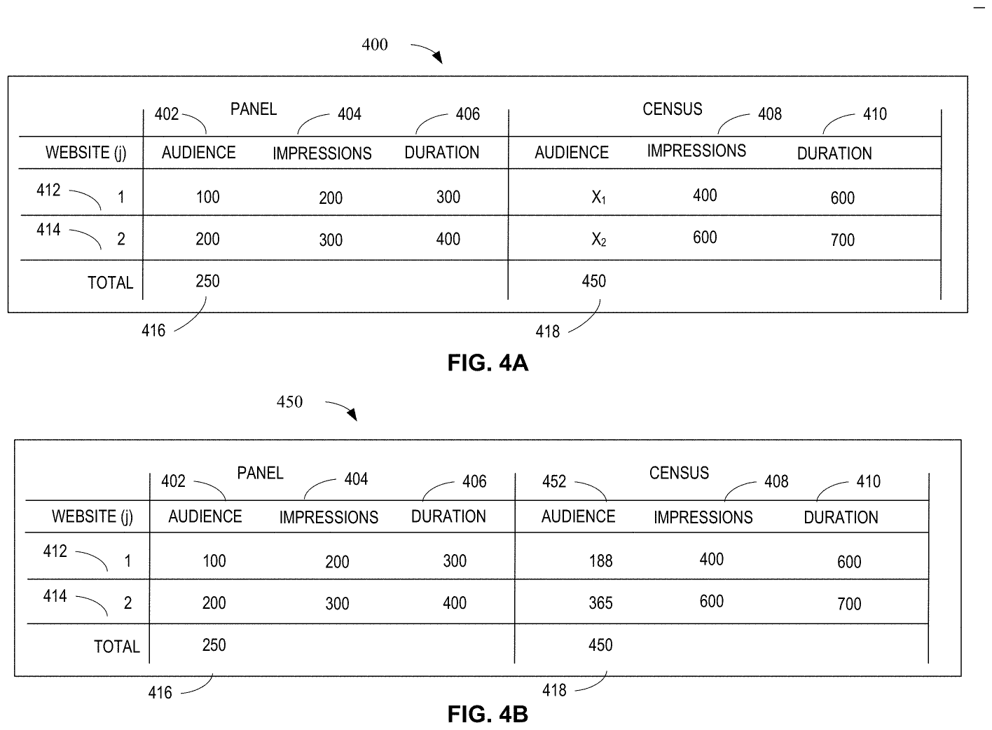

FIG. 4A is a table 400 showing example panel audience sizes 402, example panel impression counts 404, example panel event durations 406, example census impression counts 408, and example census event durations 410. That is, the panel audience sizes 402 correspond to the variable Aⱼ, the panel impression counts 404 correspond to the variable Rⱼ, the panel event durations 406 correspond to the variable Dⱼ, the census impression counts 408 correspond to the variable and the census event durations 410 correspond to the variable where j represents respective events. For example, the network interface 302 can receive the panel audience sizes 402, panel impression counts 404, and the panel event durations 406 from the panel database 102 (FIG. 1). Additionally, the network interface 302 can receive the census impression counts 408 and the census event durations 410 from the example census database 104 (FIG. 1). The example table 400 includes an example first event 412 and an example second event 414. In the illustrated example of FIG. 4A, each of the events 412, 414 represents a visit to a corresponding website. For example, the first website 412 can be google.com and the second website 414 can be facebook.com.

As described above, an audience member of an event corresponds to at least some duration of that event. For example, the first website 414 has a panel audience size of 100, a panel impression count of 200, a panel event duration of 300, a census impression count of 400, and a census event duration of 600. The example second website 410 has a panel audience size of 200, a panel impression count of 300, a panel event duration of 400, a census impression count of 600, and a census event duration of 700.

The example table 400 includes an example total panel audience size 416 and an example total census audience size 418. The example total panel audience size 416 is not the sum of the panel audience sizes of the events 412, 414. For example, 100+200≠250. In the illustrated example of FIG. 4A, the events 414, 414 are not mutually exclusive. That is, there can be overlap between the audience members of each event 412, 414. For example, an audience member of the example first event 412 can also be an audience member of the example second event 414. That is, an audience member can visit multiple websites (e.g., the events 412, 414) any number of times and/or durations.

The example table 400 includes the example total census audience size 418. In the illustrated example of FIG. 4A, the total census audience size 418 is 450. However, the example table 400 does not include census audience size for each event 412, 414. The example census information generator 310 (FIG. 3) determines census audience size estimates for each event 412, 414 based on the example panel audience sizes 402, the example panel impression counts 404, the example panel event durations 406, the example census impression counts 408, and the example census event durations 410.

FIG. 4B is an example table 450 showing the panel audience sizes 402, the panel impression counts 404, the panel event durations 406, the census impression counts 408, and the census event durations 410 of FIG. 4A, and example census audience sizes 452. That is, the example census information generator 310 (FIG. 3) can use the panel data and the determined census data of the example table 400 (FIG. 4A) to determine an example first census audience size of the example first event 412 and an example second census audience size of the example second event 414. While an AME is interested in the example total census audience size 418 (e.g., 450), additional insights into the respective events (e.g., the events 412, 414) can be accomplished by knowing how the example total census audience size 418 is distributed across the events (e.g., the first census audience size and the second census audience size).

In the illustrated example of FIG. 4B, the example total panel audience size 416, A_{●}, is 250. The example panel audience sizes 402, Aⱼ, are {100, 200}. Thus, the example universe estimate calculator 304 (FIG. 3) can use example Equation 17 to determine Q_{P} is 400 (e.g.,

$$1 - \frac{250}{{Q}_{P}} = {\prod }_{i = 1}^{n} ( 1 - \frac{{A}_{i}}{{Q}_{P}} ) for {A}_{j} = \{ 100 , 200 \} ) .$$

The example constraint equation controller 306 (FIG. 3) can use the value of Q_{P} in example Equation 16 to select constraint equations for the example first event 412 and the example second event 414, shown in example Equation 20 and Equation 21 below, respectively.

$$\begin{matrix}\frac{1}{900} = \frac{{X}_{1}^{3}}{( {Q}_{C} - {X}_{1} ) ( 400 - {X}_{1} ) 600} & ( Equation 20 ) \\ \frac{1}{400} = \frac{{X}_{2}^{3}}{( {Q}_{C} - {X}_{2} ) ( 600 - {X}_{2} ) 700} & ( Equation 21 )\end{matrix}$$

That is, the census event duration, V₁, of the example first event 412 is 600; the census impression count, Tⱼ, of the first event 412 is 400; the census event duration, V₂, of the example second event 414 is 700; and the census impression count, of the second event 414 is 600. In the illustrated example of FIG. 4B, example total census audience size 418, X_{●}, is 450. Thus, the example universe estimate calculator 304 can use example Equation 18 to determine an auxiliary equation including Q_{C}, where the auxiliary equation is shown in Equation 22 below.

$$1 - \frac{450}{{Q}_{C}} = {\prod }_{j = 1}^{n} ( 1 - \frac{{X}_{j}}{{Q}_{C}} ) \qquad ( Equation 22 )$$

The example census information generator 310 can then use example Equation 20 and Equation 21 along with the auxiliary equation (e.g., Equation 22) to determine Q_{C}=662.805 and the census audience sizes, Xⱼ, are {188.433, 365.468}. That is, the example first census audience size is 188 and the example second census audience size is 365. In some examples, the census information generator 310 stores the census audience sizes in the example census estimate database 308 (FIG. 3). In the illustrated example of FIG. 4B, each census audience size is less than or equal to the example total census audience size 418.

A flowchart representative of example hardware logic circuitry, machine readable instructions, hardware implemented state machines, and/or any combination thereof for implementing the census estimate controller 110 of FIGS. 1, 2, and 3 is shown in FIG. 5. The machine readable instructions may be one or more executable programs or portion(s) of an executable program for execution by processor circuitry, such as the processor circuitry 612 shown in the example processor platform 600 discussed below in connection with FIG. 6 and/or the example processor circuitry discussed below in connection with FIGS. 7 and/or 8. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 5, many other methods of implementing the example census estimate controller 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions which may be executed to implement the example census estimate controller 110 of FIGS. 1, 2, and/or 3 to estimate undetermined census information for multiple events. In the illustrated example of FIG. 5, an example program 500 begins as the network interface 302 of FIG. 3 accesses panel data from the panel database 102 (FIG. 1) and accesses determined census data from the census database 104 (FIG. 1). For example, the network interface 302 may access panel event durations, panel impression counts, and panel audience sizes from the panel database 102; and census event durations, census impression counts, and/or census audience sizes from the census database 104. In some examples the panel event durations, the panel impression counts, the panel audience sizes, the census event durations, the census impression counts, and/or the census audience sizes correspond to multiple events (e.g., visiting a website and watching media).

At block 502, the example census estimate controller 110 determines a panel pseudo-universe estimate Q_{P} based on the panel data. For example, the universe estimate calculator 304 (FIG. 3) obtains the panel audience sizes Aⱼ, the panel event durations Dⱼ, and the total panel audience size A_{●} from the panel data via the network interface 302. In such examples, the universe estimate calculator 304 substitutes the panel audience sizes Aⱼ, the panel event durations Dⱼ, and the total panel audience size A_{●} into Equation 17 above, and solves the equation to determine the panel pseudo-universe estimate Q_{P}.

At block 504, the example census estimate controller 110 selects constraint equations. In one example, the determined census data does not include census audience sizes for the multiple events. As a result, the constraint equation controller 306 (FIG. 3) may select Equation 16 above corresponding to each event (e.g., visiting a website and watching media). In such examples, the panel audience sizes Aⱼ, the panel event durations Dⱼ, the panel impression counts Rⱼ, the census impression counts and the census event durations Vⱼ are known, and the census audience sizes Xⱼ are unknown.

At block 506, the example census estimate controller 110 modify the constraint equations based on the panel pseudo-universe estimate Q_{P} and the panel data. The constraint equations may be modified by substituting the panel pseudo-universe estimate Q_{P} and the panel data into a first part of the constraint equations. For example, the census information generator 310 (FIG. 3) obtains the panel audience sizes Aⱼ, the panel impression counts Rⱼ, and the panel event durations Dⱼ from the panel data, and further obtains the panel pseudo-universe estimate Q_{P} via the network interface 302. In such examples, the census information generator 310 substitutes the panel audience sizes Aⱼ, the panel event durations Dⱼ, the panel impression counts Rⱼ, and the panel pseudo-universe estimate Q_{P} into the first part of the constraint equations (e.g., the left hand side of Equation 16) and determines values of the first part of the constraint equations.

At block 508, the example census estimate controller 110 modify the constraint equations based on the determined census data. The constraint equations may be modified by substituting the determined census data into a second part of the constraint equations. For example, the census information generator 310 obtains the census event durations Vⱼ and the census impression counts Tⱼ from the determined census data. In such examples, the census information generator 310 substitutes the census event durations Vⱼ and the census impression counts Tⱼ into the second part of the constraint equations (e.g., the right hand side of Equation 16). Thus, the constraint equations include the unknown variables Xⱼ corresponding to the census audience sizes and Q_{C} corresponding to a census pseudo-universe estimate.

At block 510, the example census estimate controller 110 selects an auxiliary equation corresponding to the census pseudo-universe estimate Q_{C}. For example, the universe estimate calculator 304 selects Equation 18 and substitutes a known value of the total census audience size X_{●} obtained from the determined census data. Further, the auxiliary equation includes the unknown variables Xⱼ corresponding to the census audience sizes and Q_{C} corresponding to the census pseudo-universe estimate.

At block 512, the example census estimate controller 110 selects a system of equations including the constraint equations and the auxiliary equation. For example, the census information generator 310 generates the system of equations including the constraint equations corresponding to each event (based on Equation 16) selected by the constraint equation controller 306 and further including the auxiliary equation (based on Equation 18) selected by the universe estimate calculator 304. In such examples, the system of equations includes n+1 equations and n+1 unknown variables, where n is the number of events.

At block 514, the example census estimate controller 110 solves the system of equations to determine the census information. For example, the census information generator 310 solves the system of equations to determine values for each of the unknown variables Xⱼ corresponding to the census audience sizes and Q_{C} corresponding to the census pseudo-universe estimate. In some examples, the census information generator 310 can use any numerical algorithm for solving the system of equations.

At block 516, the example census estimate controller 110 generates a report. For example, the report generator 312 (FIG. 3) generates a report including the census audience sizes corresponding to the events and/or the census pseudo-universe estimate. In some examples, additionally or alternatively, the census estimate database 308 stores the census audience sizes and/or the census pseudo-universe estimate. The program 500 ends.

FIG. 6 is a block diagram of an example processor platform 600 structured to execute and/or instantiate the machine readable instructions and/or operations of FIG. 5 to implement the census estimate controller 110 of FIGS. 1, 2, and 3. The processor platform 600 can be, for example, a server, a personal computer, a workstation, a self-learning machine (e.g., a neural network), a mobile device (e.g., a cell phone, a smart phone, a tablet such as an iPad), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 600 of the illustrated example includes processor circuitry 612. The processor circuitry 612 of the illustrated example is hardware. For example, the processor circuitry 612 can be implemented by one or more integrated circuits, logic circuits, FPGAs microprocessors, CPUs, GPUs, DSPs, and/or microcontrollers from any desired family or manufacturer. The processor circuitry 612 may be implemented by one or more semiconductor based (e.g., silicon based) devices. In this example, the processor circuitry 612 implements the network interface 302, the universe estimate calculator 304, the constraint equation controller 306, the census information generator 310, and/or the report generator 312 of FIG. 3.

The processor circuitry 612 of the illustrated example includes a local memory 613 (e.g., a cache, registers, etc.). The processor circuitry 612 of the illustrated example is in communication with a main memory including a volatile memory 614 and a non-volatile memory 616 by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617.

The processor platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 622 are connected to the interface circuitry 620. The input device(s) 622 permit(s) a user to enter data and/or commands into the processor circuitry 612. The input device(s) 622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 624 are also connected to the interface circuitry 620 of the illustrated example. The output devices 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 600 of the illustrated example also includes one or more mass storage devices 628 to store software and/or data. Examples of such mass storage devices 628 include magnetic storage devices, optical storage devices, floppy disk drives, HDDs, CDs, Blu-ray disk drives, redundant array of independent disks (RAID) systems, solid state storage devices such as flash memory devices, and DVD drives. In this example, the mass storage devices 628 implement the census estimate database 308 of FIG. 3.

The machine executable instructions 632, which may be implemented by the machine readable instructions of FIG. 5, may be stored in the mass storage device 628, in the volatile memory 614, in the non-volatile memory 616, and/or on a removable non-transitory computer readable storage medium such as a CD or DVD.

FIG. 7 is a block diagram of an example implementation of the processor circuitry 612 of FIG. 6. In this example, the processor circuitry 612 of FIG. 6 is implemented by a microprocessor 700. For example, the microprocessor 700 may implement multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowchart of FIG. 5.

The cores 702 may communicate by an example bus 704. In some examples, the bus 704 may implement a communication bus to effectuate communication associated with one(s) of the cores 702. For example, the bus 704 may implement at least one of an Inter-Integrated Circuit (I2C) bus, a Serial Peripheral Interface (SPI) bus, a PCI bus, or a PCIe bus. Additionally or alternatively, the bus 704 may implement any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2_cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the L1 cache 720, and an example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating point operations. In yet other examples, the AL circuitry 716 may include first AL circuitry that performs integer based operations and second AL circuitry that performs floating point operations. In some examples, the AL circuitry 716 may be referred to as an Arithmetic Logic Unit (ALU). The registers 718 are semiconductor-based structures to store data and/or instructions such as results of one or more of the operations performed by the AL circuitry 716 of the corresponding core 702. For example, the registers 718 may include vector register(s), SIMD register(s), general purpose register(s), flag register(s), segment register(s), machine specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure including distributed throughout the core 702 to shorten access time. The bus 720 may implement at least one of an I2C bus, a SPI bus, a PCI bus, or a PCIe bus

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 8 is a block diagram of another example implementation of the processor circuitry 612 of FIG. 6. In this example, the processor circuitry 612 is implemented by FPGA circuitry 800. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the machine readable instructions in hardware and, thus, can often execute the operations faster than they could be performed by a general purpose microprocessor executing the corresponding software.

More specifically, in contrast to the microprocessor 700 of FIG. 7 described above (which is a general purpose device that may be programmed to execute some or all of the machine readable instructions represented by the flowchart of FIG. 5 but whose interconnections and logic circuitry are fixed once fabricated), the FPGA circuitry 800 of the example of FIG. 8 includes interconnections and logic circuitry that may be configured and/or interconnected in different ways after fabrication to instantiate, for example, some or all of the machine readable instructions represented by the flowchart of FIG. 5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the software represented by the flowchart of FIG. 5. As such, the FPGA circuitry 800 may be structured to effectively instantiate some or all of the machine readable instructions of the flowchart of FIG. 5 as dedicated logic circuits to perform the operations corresponding to those software instructions in a dedicated manner analogous to an ASIC. Therefore, the FPGA circuitry 800 may perform the operations corresponding to the some or all of the machine readable instructions of FIG. 5 faster than the general purpose microprocessor can execute the same.

In the example of FIG. 8, the FPGA circuitry 800 is structured to be programmed (and/or reprogrammed one or more times) by an end user by a hardware description language (HDL) such as Verilog. The FPGA circuitry 800 of FIG. 8, includes example input/output (I/O) circuitry 802 to obtain and/or output data to/from example configuration circuitry 804 and/or external hardware (e.g., external hardware circuitry) 806. For example, the configuration circuitry 804 may implement interface circuitry that may obtain machine readable instructions to configure the FPGA circuitry 800, or portion(s) thereof. In some such examples, the configuration circuitry 804 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 806 may implement the microprocessor 700 of FIG. 7. The FPGA circuitry 800 also includes an array of example logic gate circuitry 808, a plurality of example configurable interconnections 810, and example storage circuitry 812. The logic gate circuitry 808 and interconnections 810 are configurable to instantiate one or more operations that may correspond to at least some of the machine readable instructions of FIG. 5 and/or other desired operations. The logic gate circuitry 808 shown in FIG. 8 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations. The logic gate circuitry 808 may include other electrical structures such as look-up tables (LUTs), registers (e.g., flip-flops or latches), multiplexers, etc.

The interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example Dedicated Operations Circuitry 814. In this example, the Dedicated Operations Circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 5 and 6 illustrate two example implementations of the processor circuitry 612 of FIG. 6, many other approaches are contemplated. For example, as mentioned above, modern FPGA circuitry may include an on-board CPU, such as one or more of the example CPU 820 of FIG. 8. Therefore, the processor circuitry 612 of FIG. 6 may additionally be implemented by combining the example microprocessor 700 of FIG. 7 and the example FPGA circuitry 800 of FIG. 8. In some such hybrid examples, a first portion of the machine readable instructions represented by the flowchart of FIG. 5 may be executed by one or more of the cores 702 of FIG. 7 and a second portion of the machine readable instructions represented by the flowchart of FIG. 5 may be executed by the FPGA circuitry 800 of FIG. 8.

In some examples, the processor circuitry 612 of FIG. 6 may be in one or more packages. For example, the processor circuitry 700 of FIG. 7 and/or the FPGA circuitry 700 of FIG. 7 may be in one or more packages. In some examples, an XPU may be implemented by the processor circuitry 612 of FIG. 6, which may be in one or more packages. For example, the XPU may include a CPU in one package, a DSP in another package, a GPU in yet another package, and an FPGA in still yet another package.

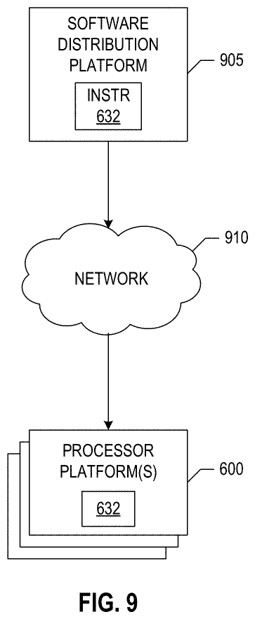

A block diagram illustrating an example software distribution platform 905 to distribute software such as the example machine readable instructions 632 of FIG. 6 to hardware devices owned and/or operated by third parties is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions 500 of FIG. 5, as described above. The one or more servers of the example software distribution platform 905 are in communication with a network 910, which may correspond to any one or more of the Internet and/or any of the example networks 626 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 905. For example, the software, which may correspond to the example machine readable instructions 632 of FIG. 6, may be downloaded to the example processor platform 600, which is to execute the machine readable instructions 632 to implement the example census estimate controller 110 of FIGS. 1, 2, and 3. In some example, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices.

From the foregoing, it will be appreciated that example methods and apparatus have been disclosed that estimate undetermined census information that has multiple dimensions. The multiple dimensions correspond to multiple events such as, for example, videos (e.g., video 1, video2, and video3). The estimated undetermined census information is based on determined census data and panel data. The determined census data is partial census data because it does not include the undetermined census information. The disclosed methods and apparatus improve the efficiency of using a computing device by storing variables, rather than combinations of possible events, reduces the amount of memory needed to store the variables. The disclosed methods and apparatus are accordingly directed to one or more improvement(s) in the operation of a machine such as a computer or other electronic and/or mechanical device.

Example methods and apparatus to determine census information of events are disclosed herein. Further examples and combinations thereof include the following:

Example 1 includes an apparatus comprising a universe estimate calculator to determine an auxiliary equation based on census data corresponding to a first event and a second event, a constraint equation controller to select a first constraint equation and a second constraint equation based on the census data, the first constraint equation corresponding to the first event, the second constraint equation corresponding to the second event, a census information generator to determine first census information and second census information based on the auxiliary equation, the first constraint equation, the second constraint equation, panel data, and the census data, the first census information corresponding to the first event, the second census information corresponding to the second event, the first census information and the second census information not included in the census data, and a report generator to generate a report including the first census information and the second census information.

Example 2 includes the apparatus of example 1, wherein the universe estimate calculator is to determine a panel pseudo-universe estimate based on the panel data.

Example 3 includes the apparatus of example 2, wherein the census information generator is to determine the first census information and the second census information further based on the panel pseudo-universe estimate.

Example 4 includes the apparatus of example 1, wherein the universe estimate calculator is to determine the auxiliary equation by selecting the auxiliary equation including variables, and modifying a set of the variables based on the census data.

Example 5 includes the apparatus of example 1, wherein the first constraint equation includes first variables, wherein the second constraint equation includes second variables, wherein the census information generator is to determine the first census information and the second census information by modifying a set of the first variables and a set of the second variables based on the panel data, the census data, and a panel pseudo-universe estimate, selecting a system of equations including the auxiliary equation, the first constraint equation, and the second constraint equation, and solving the system of equations for the first census information and the second census information.

Example 6 includes the apparatus of example 1, wherein the first census information and the second census information correspond to census impression counts, census audience sizes, panel event durations, or a total census audience size.

Example 7 includes the apparatus of example 1, wherein the panel data includes a first panel audience size, a first panel impression count, and a first panel event duration corresponding to the first event, a second panel audience size, a second panel impression count, and a second panel event duration corresponding to the second event, and a total panel audience size corresponding to the first event and the second event.

Example 8 includes the apparatus of example 1, wherein the census data includes a first census impression count and a first census event duration corresponding to the first event, a second census impression count and a second panel event duration corresponding to the second event, and a total census audience size corresponding to the first event and the second event.

Example 9 includes the apparatus of example 8, wherein the first census information corresponds to a first census audience size, wherein the second census information corresponds to a second census audience size.

Example 10 includes the apparatus of example 8, wherein the constraint equation controller is to select the first constraint equation and the second constraint equation based on the census data not including a first census audience size and a second census audience size.

Example 11 includes a non-transitory computer readable medium comprising instructions that when executed cause at least one processor to determine an auxiliary equation based on census data corresponding to a first event and a second event, select a first constraint equation and a second constraint equation based on the census data, the first constraint equation corresponding to the first event, the second constraint equation corresponding to the second event, determine first census information and second census information based on the auxiliary equation, the first constraint equation, the second constraint equation, panel data, and the census data, the first census information corresponding to the first event, the second census information corresponding to the second event, the first census information and the second census information not included in the census data, and generate a report including the first census information and the second census information.

Example 12 includes the non-transitory computer readable medium of example 11, wherein the at least one processor is to determine a panel pseudo-universe estimate based on the panel data.

Example 13 includes the non-transitory computer readable medium of example 12, wherein the at least one processor is to determine the first census information and the second census information further based on the panel pseudo-universe estimate.

Example 14 includes the non-transitory computer readable medium of example 11, wherein the at least one processor is to determine the auxiliary equation by selecting the auxiliary equation including variables, and modifying a set of the variables based on the census data.

Example 15 includes the non-transitory computer readable medium of example 11, wherein the first constraint equation includes first variables, wherein the second constraint equation includes second variables, wherein the at least one processor is to determine the first census information and the second census information by modifying a set of the first variables and a set of the second variables based on the panel data, the census data, and a panel pseudo-universe estimate, selecting a system of equations including the auxiliary equation, the first constraint equation, and the second constraint equation, and solving the system of equations for the first census information and the second census information.

Example 16 includes the non-transitory computer readable medium of example 11, wherein the first census information and the second census information correspond to census impression counts, census audience sizes, panel event durations, or a total census audience size.

Example 17 includes the non-transitory computer readable medium of example 11, wherein the panel data includes a first panel audience size, a first panel impression count, and a first panel event duration corresponding to the first event, a second panel audience size, a second panel impression count, and a second panel event duration corresponding to the second event, and a total panel audience size corresponding to the first event and the second event.

Example 18 includes the non-transitory computer readable medium of example 11, wherein the census data includes a first census impression count and a first census event duration corresponding to the first event, a second census impression count and a second panel event duration corresponding to the second event, and a total census audience size corresponding to the first event and the second event.

Example 19 includes the non-transitory computer readable medium of example 18, wherein the first census information corresponds to a first census audience size, wherein the second census information corresponds to a second census audience size.

Example 20 includes the non-transitory computer readable medium of example 18, wherein the at least one processor is to select the first constraint equation and the second constraint equation based on the census data not including a first census audience size and a second census audience size.

Example 21 includes an apparatus comprising at least one memory, instructions, and at least one processor to execute the instructions to at least determine an auxiliary equation based on census data corresponding to a first event and a second event, select a first constraint equation and a second constraint equation based on the census data, the first constraint equation corresponding to the first event, the second constraint equation corresponding to the second event, determine first census information and second census information based on the auxiliary equation, the first constraint equation, the second constraint equation, panel data, and the census data, the first census information corresponding to the first event, the second census information corresponding to the second event, the first census information and the second census information not included in the census data, and generate a report including the first census information and the second census information.

Example 22 includes the apparatus of example 21, wherein the at least one processor is to determine a panel pseudo-universe estimate based on the panel data.

Example 23 includes the apparatus of example 22, wherein the at least one processor is to determine the first census information and the second census information further based on the panel pseudo-universe estimate.

Example 24 includes the apparatus of example 21, wherein the at least one processor is to determine the auxiliary equation by selecting the auxiliary equation including variables, and modifying a set of the variables based on the census data.

Example 25 includes the apparatus of example 21, wherein the first constraint equation includes first variables, wherein the second constraint equation includes second variables, wherein the at least one processor is to determine the first census information and the second census information by modifying a set of the first variables and a set of the second variables based on the panel data, the census data, and a panel pseudo-universe estimate, selecting a system of equations including the auxiliary equation, the first constraint equation, and the second constraint equation, and solving the system of equations for the first census information and the second census information.

Example 26 includes the apparatus of example 21, wherein the first census information and the second census information correspond to census impression counts, census audience sizes, panel event durations, or a total census audience size.

Example 27 includes the apparatus of example 21, wherein the panel data includes a first panel audience size, a first panel impression count, and a first panel event duration corresponding to the first event, a second panel audience size, a second panel impression count, and a second panel event duration corresponding to the second event, and a total panel audience size corresponding to the first event and the second event.

Example 28 includes the apparatus of example 21, wherein the census data includes a first census impression count and a first census event duration corresponding to the first event, a second census impression count and a second panel event duration corresponding to the second event, and a total census audience size corresponding to the first event and the second event.

Example 29 includes the apparatus of example 28, wherein the first census information corresponds to a first census audience size, wherein the second census information corresponds to a second census audience size.

Example 30 includes the apparatus of example 28, wherein the at least one processor is to select the first constraint equation and the second constraint equation based on the census data not including a first census audience size and a second census audience size.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. An apparatus comprising:
a universe estimate calculator to determine an auxiliary equation based on census data corresponding to a first event and a second event;
a constraint equation controller to select a first constraint equation and a second constraint equation based on the census data, the first constraint equation corresponding to the first event, the second constraint equation corresponding to the second event;
a census information generator to determine first census information and second census information based on the auxiliary equation, the first constraint equation, the second constraint equation, panel data, and the census data, the first census information corresponding to the first event, the second census information corresponding to the second event, the first census information and the second census information not included in the census data; and
a report generator to generate a report including the first census information and the second census information.

2. The apparatus of claim 1, wherein the universe estimate calculator is to determine a panel pseudo-universe estimate based on the panel data.

3. The apparatus of claim 2, wherein the census information generator is to determine the first census information and the second census information further based on the panel pseudo-universe estimate.

4. The apparatus of claim 1, wherein the universe estimate calculator is to determine the auxiliary equation by:
selecting the auxiliary equation including variables; and
modifying a set of the variables based on the census data.

5. The apparatus of claim 1, wherein the first constraint equation includes first variables, wherein the second constraint equation includes second variables, wherein the census information generator is to determine the first census information and the second census information by:
modifying a set of the first variables and a set of the second variables based on the panel data, the census data, and a panel pseudo-universe estimate.
selecting a system of equations including the auxiliary equation, the first constraint equation, and the second constraint equation; and
solving the system of equations for the first census information and the second census information.

6. (canceled)

7. (canceled)

8. The apparatus of claim 1, wherein the census data includes:
a first census impression count and a first census event duration corresponding to the first event;
a second census impression count and a second panel event duration corresponding to the second event; and
a total census audience size corresponding to the first event and the second event.

9. (canceled)

10. The apparatus of claim 8, wherein the constraint equation controller is to select the first constraint equation and the second constraint equation based on the census data not including a first census audience size and a second census audience size.

11. A non-transitory computer readable medium comprising instructions that when executed cause at least one processor to:
determine an auxiliary equation based on census data corresponding to a first event and a second event;
select a first constraint equation and a second constraint equation based on the census data, the first constraint equation corresponding to the first event, the second constraint equation corresponding to the second event;
determine first census information and second census information based on the auxiliary equation, the first constraint equation, the second constraint equation, panel data, and the census data, the first census information corresponding to the first event, the second census information corresponding to the second event, the first census information and the second census information not included in the census data; and
generate a report including the first census information and the second census information.

12. The non-transitory computer readable medium of claim 11, wherein the at least one processor is to determine a panel pseudo-universe estimate based on the panel data.

13. The non-transitory computer readable medium of claim 12, wherein the at least one processor is to determine the first census information and the second census information further based on the panel pseudo-universe estimate.

14. The non-transitory computer readable medium of claim 11, wherein the at least one processor is to determine the auxiliary equation by:
selecting the auxiliary equation including variables; and
modifying a set of the variables based on the census data.

15. The non-transitory computer readable medium of claim 11, wherein the first constraint equation includes first variables, wherein the second constraint equation includes second variables, wherein the at least one processor is to determine the first census information and the second census information by:
modifying a set of the first variables and a set of the second variables based on the panel data, the census data, and a panel pseudo-universe estimate.
selecting a system of equations including the auxiliary equation, the first constraint equation, and the second constraint equation; and
solving the system of equations for the first census information and the second census information.

16. (canceled)

17. The non-transitory computer readable medium of claim 11, wherein the panel data includes:
a first panel audience size, a first panel impression count, and a first panel event duration corresponding to the first event;
a second panel audience size, a second panel impression count, and a second panel event duration corresponding to the second event; and
a total panel audience size corresponding to the first event and the second event.

18. The non-transitory computer readable medium of claim 11, wherein the census data includes:
a first census impression count and a first census event duration corresponding to the first event;
a second census impression count and a second panel event duration corresponding to the second event; and
a total census audience size corresponding to the first event and the second event.

19. (canceled)

20. The non-transitory computer readable medium of claim 18, wherein the at least one processor is to select the first constraint equation and the second constraint equation based on the census data not including a first census audience size and a second census audience size.

21. An apparatus comprising:
at least one memory;
instructions; and
at least one processor to execute the instructions to at least:
determine an auxiliary equation based on census data corresponding to a first event and a second event;
select a first constraint equation and a second constraint equation based on the census data, the first constraint equation corresponding to the first event, the second constraint equation corresponding to the second event;
determine first census information and second census information based on the auxiliary equation, the first constraint equation, the second constraint equation, panel data, and the census data, the first census information corresponding to the first event, the second census information corresponding to the second event, the first census information and the second census information not included in the census data; and
generate a report including the first census information and the second census information.

22. The apparatus of claim 21, wherein the at least one processor is to determine a panel pseudo-universe estimate based on the panel data.

23. The apparatus of claim 22, wherein the at least one processor is to determine the first census information and the second census information further based on the panel pseudo-universe estimate.

24. The apparatus of claim 21, wherein the at least one processor is to determine the auxiliary equation by:
selecting the auxiliary equation including variables; and
modifying a set of the variables based on the census data.

25. The apparatus of claim 21, wherein the first constraint equation includes first variables, wherein the second constraint equation includes second variables, wherein the at least one processor is to determine the first census information and the second census information by:
modifying a set of the first variables and a set of the second variables based on the panel data, the census data, and a panel pseudo-universe estimate.
selecting a system of equations including the auxiliary equation, the first constraint equation, and the second constraint equation; and
solving the system of equations for the first census information and the second census information.

26. (canceled)

27. (canceled)

28. The apparatus of claim 21, wherein the census data includes:
a first census impression count and a first census event duration corresponding to the first event;
a second census impression count and a second panel event duration corresponding to the second event; and
a total census audience size corresponding to the first event and the second event.

29. (canceled)

30. The apparatus of claim 28, wherein the at least one processor is to select the first constraint equation and the second constraint equation based on the census data not including a first census audience size and a second census audience size.
